(19) United States
(12) Patent Application Publication
(10) Pub. No.: US 2009/0178406 A1
(43) Pub. Date: Jul. 16, 2009

(54) APPARATUS, SYSTEM, AND METHOD FOR UTILIZING A DIESEL AFTERTREATMENT DEVICE BETWEEN THE HIGH PRESSURE AND LOW PRESSURE TURBINE STAGES OF A TWO-STAGE TURBOCHARGING SYSTEM

(76) Inventors: Jeffrey Matthews, Columbus, IN (US); Adrian P. Dale, Columbus, IN (US)

Correspondence Address: Kunzler & McKenzie, 8 EAST BROADWAY, SUITE 600, SALT LAKE CITY, UT, 84111, US

(21) Appl. No.: 12/013,965

(22) Filed: Jan. 14, 2008

(51) Int. Cl. F01N 5/00; F02D 23/00; F01N 3/10

(52) U.S. Cl. 60/602; 60/274; 60/299

(57) ABSTRACT

An apparatus, system, and method are disclosed for utilizing a diesel aftertreatment device between the high pressure and low pressure turbine stages of a two-stage turbocharging system. A diesel aftertreatment device is connected in series between the high pressure turbine and the low pressure turbine such that the diesel aftertreatment device receives inflow from the high pressure turbine and provides outflow to the low pressure turbine. A bypass mechanism is provided such that at low engine speeds or loads, engine exhaust flows through the high pressure turbine as well as the diesel aftertreatment device, but at high engine speeds or loads, the high pressure turbine and diesel aftertreatment device are bypassed, thereby allowing the engine to operate more efficiently while still effectively removing pollutants from the engine exhaust.

### BACKGROUND OF THE INVENTION

1. Field of the Invention

This invention relates to the oxidation of particulates emitted from motor exhaust and more particularly relates to an apparatus, system, and method for utilizing a diesel aftertreatment device between the high pressure and low pressure turbine stages of a two-stage turbocharging system.

2. Description of the Related Art

A turbocharger is an exhaust-gas driven forced induction device used in internal combustion engines to improve engine performance by forcing compressed air into combustion chambers. This allows more fuel to be burned resulting in a larger power output. A turbocharger typically comprises a turbine and a compressor linked by a shared axis. The turbine inlet of a turbocharger receives exhaust gases from the engine exhaust manifold causing the turbine wheel to rotate. This rotation drives the compressor, compressing ambient air and delivering it to the air intake engine. Turbocharging is particularly common on diesel engines in conventional automobiles, in trucks, locomotives, and for marine and heavy machinery applications.

The objective of a turbocharger is to improve upon the size-to-output efficiency of an engine by controlling intake pressure of air into the combustion chamber. A typical automobile engine uses only the downward stroke of a piston to create an area of low pressure in order to draw air into the cylinder. Because the number of air and fuel molecules determine the potential energy available to force the piston down on the combustion stroke, and because of the relatively constant pressure of the atmosphere, there ultimately will be a limit to the amount of air and consequently fuel filling the combustion chamber. A turbocharger increases the pressure at the point where air is entering the cylinder. Subsequently, the amount of air brought into the cylinder is largely a function of time and pressure, such that more air will be drawn in as the pressure increases. A turbocharger allows the intake pressure to be controllably increased for improved performance and efficiency.

However, a lag is sometimes produced by the reaction time of a turbocharger because of the time it takes for the exhaust system driving the turbine to come to high pressure and for the turbine rotor to overcome its rotational inertia and subsequently reach the speed necessary to supply the appropriate boost pressure. One way to reduce lag is by changing the aspect ratio of the turbine by reducing the diameter of the turbine and decreasing the gas-flow path-length. However, even though a small diameter turbine will reduce the lag time response of a turbocharger, at elevated engine speeds a larger diameter turbine may be desired in to provide adequate air handling capacity and increased efficiency. In order to address this problem, conventional artisans have implemented two-stage turbo systems such as a sequential turbo system or a compound turbo system.

In one embodiment of a two stage turbocharger, the smaller diameter turbocharger may create exhaust backpressure thereby forcing the recirculation of exhaust gas through an EGR cooler, EGR valve, and associated piping to the intake manifold. Since for some emissions cycles, the recirculation of exhaust gas is only required at relatively low engine speed and load, the backpressure associated with the smaller turbocharger can be avoided by routing the exhaust gas around that turbocharger at elevated engine speed and load.

Sequential turbo systems comprise at least one high-pressure turbocharger (smaller diameter turbine) for lower engine speeds and loads, and at least one low-pressure turbocharger (larger diameter turbine) for higher engine speeds and loads. Typically, during low to mid engine speeds and loads, when available spent exhaust energy is minimal, the engine's entire exhaust energy is directed to the high-pressure turbocharger, thereby lowering the boost threshold, while increasing power and performance. Although the exhaust gas does pass through the lower pressure turbine, the increase in boost pressure associated with the low pressure compressor is relatively small at low to mid engine speed and loads. As engine speed and load increases, a valve bypassing exhaust gas around the high pressure turbine begins to open in a predetermined manner and ultimately achieves a full-open position. As the high pressure turbine bypass valve opens, more of the exhaust energy is directed to the low pressure turbine and, consequently, the boost pressure associated with the lower pressure compressor begins to increase. As engine speed and load continue to increase, the high pressure compressor begins to act as a flow restriction. At a predetermined engine operating point, a valve bypassing fresh air around the high pressure compressor opens. At this point and at higher engine speed and load, engine boost pressure is nearly all generated by the low pressure turbocharger.

Compound turbocharging is a technique used to achieve extremely high pressure ratios by having one turbocharger pressurize the air coming into the inlet of another. Compound turbocharging can effectively reduce turbo lag and can create high power levels. Furthermore, a compound turbocharger may be used to generate backpressure at low engine speed and load to promote the recirculation of exhaust gas to the intake manifold while still generating enough boost to provide sufficient fresh air flow into the cylinder.

Today, modern diesel emissions regulations are driving engine manufacturers to search for more efficient ways to reduce emissions without significantly affecting engine performance. With regard to diesel engines, manufacturers are likely to use a diesel aftertreatment device, such as a diesel oxidation catalyst (DOC), to oxidize hydrocarbons in the exhaust gas of a diesel engine. In motors utilizing a turbocharger, the diesel oxidation catalyst is typically placed in the exhaust stack such that all exhaust flow must pass through the catalyst. However, the pressure drop across the catalyst restricts air flow, thereby increasing exhaust gas temperatures and increasing fuel consumption such that efficiency is significantly reduced. This drop in efficiency is a problem for which conventional art has yet to provide an adequate remedy.

The exhaust temperatures of an engine using a two-stage turbocharging system to control emissions in-cylinder may be too low to initiate and sustain the oxidation of unburned hydrocarbons at reduced engine speeds and loads, and therefore a catalyst is needed to promote the oxidation of those emissions. However, an engine operating at elevated speeds and loads produces little or no unburned hydrocarbons, and therefore a restrictive aftertreatment device may be ineffective or unnecessary at elevated engine levels.

From the foregoing discussion, it should be apparent that a need exists for an apparatus, system, and method that can overcome the limitations of current diesel exhaust emission aftertreatment systems. Beneficially, such an apparatus, system, and method would utilize an aftertreatment device at low engine speeds loads and would bypass the restrictive aftertreatment device at high engine speeds and loads.

### SUMMARY OF THE INVENTION

The present invention has been developed in response to the present state of the art, and in particular, in response to the problems and needs in the art that have not yet been fully solved by currently available emission aftertreatment systems. Accordingly, the present invention has been developed to provide an apparatus, method, and system for more efficient treatment of emissions in an engine utilizing a two-stage (or higher multiple) turbo charging system.

The apparatus, in one embodiment, includes a two-stage turbo charging system comprising a high pressure turbine and a low pressure turbine. The apparatus also includes a diesel aftertreatment device connected in series between the high pressure turbine and the low pressure turbine such that the diesel aftertreatment device receives inflow from the high pressure turbine and provides outflow to the low pressure turbine.

In one embodiment, the apparatus further comprises a second diesel aftertreatment device connected to the low pressure turbine such that the second diesel aftertreatment device receives outflow from the low pressure turbine.

In a further embodiment, the apparatus further comprises a bypass mechanism, wherein the bypass mechanism is configured to provide inflow directly to the low pressure turbine such that the high pressure turbine and diesel aftertreatment device are bypassed. In such an embodiment, the apparatus may further comprise a bypass control module, wherein the bypass control module is configured to control the operation of the bypass mechanism. In a further embodiment, the bypass control module may be configured to operate the bypass mechanism such that the high pressure turbine and the diesel aftertreatment device are bypassed in response to the detection of a predetermined engine operating condition such as load or engine speed or other engine operating characteristics such as temperatures or pressures.

In a preferred embodiment, the diesel aftertreatment device is a diesel oxidation catalyst. In various other embodiments, a NAC (NOx Adsorber Catalyst) or traditional 3-way catalyst or other devices recognized by those of skill in the art may be used.

A system of the present invention is also presented. The system includes a vehicle having a motor, an exhaust system, a two-stage turbo charging system, and diesel aftertreatment device wherein the diesel aftertreatment device is connected in series between the high pressure turbine and the low pressure turbine such that the diesel aftertreatment device receives inflow from the high pressure turbine and provides outflow to the low pressure turbine.

Various embodiments of the system substantially include the various embodiments described above with respect to the apparatus.

A method of the present invention is also presented, and includes providing a two-stage turbo charging system comprising a high pressure turbine and a low pressure turbine; connecting a diesel aftertreatment device in series between the high pressure turbine and the low pressure turbine such that the diesel aftertreatment device receives inflow from the high pressure turbine and provides outflow to the low pressure turbine; and providing a bypass mechanism, the bypass mechanism configured to provide inflow to the low pressure turbine such that the high pressure turbine and diesel aftertreatment device are bypassed.

In one embodiment, the method further comprises connecting a second diesel aftertreatment device to the low pressure turbine such that the second diesel aftertreatment device receives outflow from the low pressure turbine. In another embodiment, the method further comprises providing a bypass control module, the bypass control module configured to control the operation of the bypass mechanism. In various embodiments, the bypass control module is further configured to operate the bypass mechanism such that the high pressure turbine and the diesel aftertreatment device are bypassed in response to the detection of a predetermined engine speed or engine load or other operating condition.

Discussion of the features and advantages, and similar language, throughout this specification may, but do not necessarily, refer to the same embodiment. Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts one embodiment of a two-stage turbocharging system in accordance with the present invention;

FIG. 2 depicts an additional embodiment of a two-stage turbocharging system in accordance with the present invention; and

FIG. 3 is a schematic flow chart diagram illustrating one embodiment of a method for utilizing a diesel aftertreatment device between the high pressure and low pressure turbine stages of a two-stage turbocharging system.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a computer readable medium may take any form capable of generating a signal, causing a signal to be generated, or causing execution of a program of machine-readable instructions on a digital processing apparatus. A computer readable medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

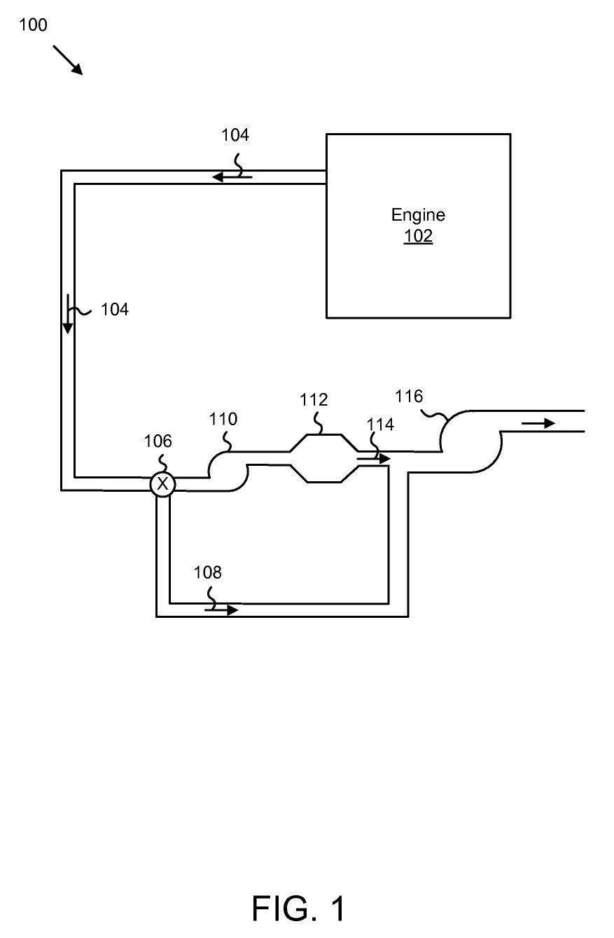

FIG. 1 depicts one embodiment of a two-stage turbocharging system 100 in accordance with the present invention. The system 100 includes an engine 102, an exhaust outflow 104, a bypass mechanism 106, a bypass flow 108, a high pressure turbine 110, a diesel aftertreatment device 112, a treated exhaust flow 114, and a low pressure turbine 116.

The engine 102 may be any type of internal combustion engine such as those used in cars, trucks, airplanes, and other types of motorized vehicles. Preferably, engine 102 is a diesel engine that runs on diesel fuel (petrodiesel). The engine 102 operates such that it combusts fuel for conversion to mechanical energy resulting in the emission of exhaust gases and particulates, herein referred to as exhaust flow 104. The exhaust flow 104 typically includes gases such as nitrogen, carbon dioxide, carbon monoxide, hydrocarbons, nitrogen oxides, and other particulate matter.

In one embodiment, the exhaust flow 104 flows into the bypass mechanism 106. The bypass mechanism 106 operates to provide differing inflow to the high pressure turbine 110. For example, at low engine speeds or loads, such as when a vehicle is just starting to accelerate, the bypass mechanism 106 may operate such that all of the exhaust flow 104 is routed to the high pressure turbine 110. This allows the high pressure turbine 110 to more quickly reach its optimal operating speed, thereby reducing the lag time of the turbocharger. Conversely, at high engine speeds or loads, the bypass mechanism 106 may operate to substantially bypass the high pressure turbine 110 and diesel aftertreatment device 112 such that most or all of the bypass flow 108 is directly routed to the low pressure turbine. Bypassing the high pressure turbine 110 during high engine speeds or loads reduces restriction in the exhaust stream and avoids the possibility of excessive high pressure turbocharger rotational speeds.

Thus, by reducing the exhaust stream restriction caused by the high pressure turbine 110 at high engine speeds or loads, air flow is increased thereby reducing both exhaust gas temperatures and fuel consumption. Furthermore, the two-stage turbocharger helps to generate backpressure at low engine speeds and loads to promote the recirculation of exhaust gas to the intake manifold in order to facilitate cleaner emissions. For example, the recirculation of exhaust gas allows the engine output of NOx emissions to be kept to a minimum for certification in an emissions test such as an FTP75 cycle.

Output exhaust from the high pressure turbine 110 flows into the diesel aftertreatment device 112. The diesel aftertreatment device 112 is a device designed to cleanse the exhaust flow 104, but which constitutes a flow restriction that results in decreased system efficiency. In a diesel engine, a diesel aftertreatment device 112, may be used to effectively prevent pollutants from entering the atmosphere. The diesel aftertreatment device 112 may in various embodiments be implemented as a diesel oxidation catalyst or a particulate filter; i.e. a cordierite wall flow filter, a silicon carbide wall flow filter, a metal fiber flow through filter, a paper filter, or other type of filter as will be recognized by one of skill in the art. In various other embodiments, an NAC (NOx Adsorber Catalyst) or traditional 3-way catalyst or other device recognized by one of skill in the art may be used. Preferably, a diesel oxidation catalyst 112 is used in conjunction with a diesel engine 102.

Because an engine 102 operating at low engine speeds or loads produces an exhaust flow 104 that has too low of a temperature to initiate and sustain the oxidation of unburned hydrocarbons, and because the bypass mechanism 106 is preferably configured to pass exhaust flow primarily through the high pressure turbine 110 when the engine 102 is operating at low engine speeds or loads, the diesel aftertreatment device 112 is connected to the output of the high pressure turbine 110 such that the diesel aftertreatment device 112 cleanses the lower temperature exhaust flow 104 in order to remove the unburned hydrocarbons and other pollutants. Thus, at lower exhaust temperatures, most or all of the exhaust flow 104 passes through the diesel aftertreatment device 112.

The diesel aftertreatment device 112 subsequently provides the cleansed exhaust flow 114 to the input of the low pressure turbine 116.

Conversely, when the engine 102 is operating at higher engine speeds or loads, the engine 102 produces little or no unburned hydrocarbons because of the higher operating temperatures. Furthermore, in some instances at higher speeds and loads may not be regulated thereby eliminating the need for utilization of a diesel aftertreatment device 112. Therefore, when the engine 102 is operating at higher engine speeds or loads, the diesel aftertreatment device 112 can be substantially bypassed such that the bypass flow 108 is routed directly to the low pressure turbine 116 thereby reducing or eliminating the flow restriction typically caused by the high pressure turbine 110 and the diesel aftertreatment device 112. In this manner, the system 100 is able to operate more efficiently.

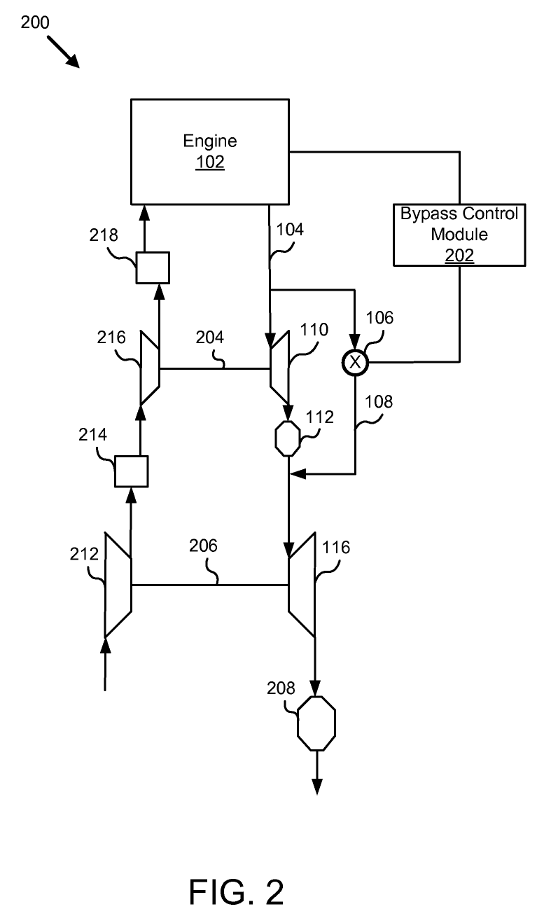

FIG. 2 depicts an additional embodiment of a two-stage turbocharging system 200 in accordance with the present invention. The system 200 includes an engine 102, an exhaust outflow 104, a bypass mechanism 106, a bypass flow 108, a high pressure turbine 110, a diesel aftertreatment device 112, a cleansed exhaust flow 114, a low pressure turbine 116, a bypass control module 202, rotating shafts 204 and 206, a second diesel aftertreatment device 208, a low pressure compressor 212, an intercooler 214, a high pressure compressor 216, and an after cooler 218.

The operation of the engine 102, the exhaust flow 104, the bypass mechanism 106, the bypass flow 108, the high pressure turbine 110, the diesel aftertreatment device 112, the filtered exhaust flow 114, and the low pressure turbine 116 is substantially described above with regard to FIG. 1.

The bypass control module 202 is configured to control the operation of the bypass mechanism 106. In one embodiment, the bypass control module 202 receives signals indicating the current engine speed or load of the engine 102. The bypass control module 202 may be configured to operate the bypass mechanism 106 such that the high pressure turbine and the diesel aftertreatment device 112 are bypassed in response to the detection of a predetermined engine operating condition such as the engine speed, engine load, or operating temperature, manifold pressure, or turbocharger speeds. For example, in one embodiment, the bypass control module 202 may be configured to operate the bypass mechanism 106 such that the high pressure turbine 110 and the diesel aftertreatment device 112 are bypassed in response to the detection of a high engine load.

In various embodiments, the detection of an engine operating condition may be dependent on engine sensors such as speed sensors, engine temperature sensors, exhaust temperature sensors, rpm sensors and other sensors as will be recognized by one of skill in the art.

The bypass control module 202 provides an output signal to the bypass mechanism 106 such that the bypass mechanism 106 operates in response to the output signal. For example, the signal might cause the bypass mechanism 106 to provide all of the exhaust flow 104 to the high pressure turbine 110, or it may cause the bypass mechanism 106 to provide all or substantially all of the exhaust flow 104 to the low pressure turbine 116, thereby bypassing the high pressure turbine 110 and the diesel aftertreatment device 112.

The high pressure turbine 110 is connected via the rotating shaft 204 to the high pressure compressor 216, and the low pressure turbine 116 is connected via the rotating shaft 206 to the low pressure compressor 212. As the exhaust flow 104 passes through the turbines 110 and 116, the turbines are caused to rotate or spin. The rotating turbines 110 and 116 cause the rotating shafts 204 and 206 to rotate, which in turn drives the compressors 212 and 216.

The low pressure compressor 212 receives as an input ambient air suitable for flow into the combustion engine 102. In one embodiment, the outflow of the low pressure compressor 212 may pass through an intercooler 214. The intercooler 214 cools the ambient air which may have an elevated temperature resulting from the compression caused by the low pressure compressor 212. In one embodiment, the intercooler 214 provides the cooled air as inflow to the high pressure compressor 216.

The high pressure compressor 216 operates much like the low pressure compressor 212 and receives as an input ambient air which is compressed to a higher pressure. In one embodiment, the high pressure compressor 216 receives as an input cooled air from the intercooler 214 or receives air directly from the low pressure compressor 212. Again, the compressed air may obtain an elevated temperature, and in one embodiment, an after cooler 218 may be provided to cool the pressurized air prior to its introduction to the engine 102. Finally, the compressed air is provided to the engine 102 where the compressed air is forced into combustion chambers for increased efficiency in the operation of the engine 102. In one embodiment, a compressor bypass valve (not shown) may be provided on the intake side. In one embodiment, the compressor bypass valve is binary and opens after the bypass mechanism 106 has fully opened. The purpose of the compressor bypass valve is to avoid a flow restriction due to the high pressure compressor when the high pressure turbine 110 is being bypassed.

In one embodiment, a second diesel aftertreatment device 208 is provided at the output of the low pressure turbine 116 such that the second diesel aftertreatment device 208 receives exhaust flow from the low pressure turbine 116. Preferably, the second diesel aftertreatment device 208 is less restrictive of airflow than is the first diesel aftertreatment device 112. However, in one embodiment, the second diesel aftertreatment device 208 may also be less effective in removing pollutants from the exhaust flow 104.

Because the exhaust flowing through the second diesel aftertreatment device 208 is likely to have already either passed through the first diesel aftertreatment device 112 or to have been generated at high engine speeds or loads, where, for a chassis certified product, emissions may be unregulated, then it is unnecessary to implement a highly restrictive diesel aftertreatment device 208. However, because there may be minimal amounts of regulated exhaust species or particulate that reach the low pressure turbine 116, the second diesel aftertreatment device 208 may be provided to cleanse these remaining regulated exhaust species or particulates in a less restrictive manner without substantially reducing the efficiency of the system 200.

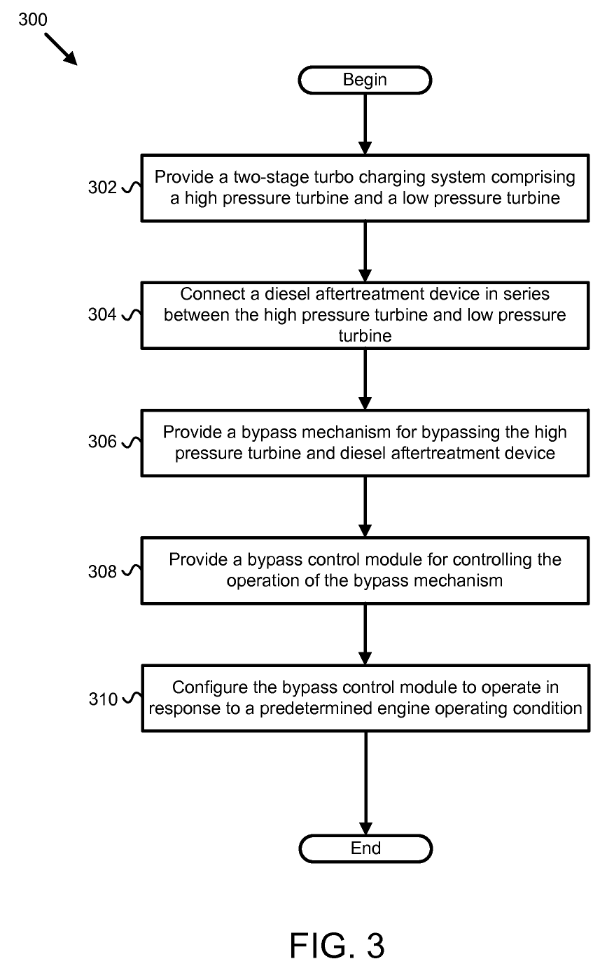

FIG. 3 is a schematic flow chart diagram illustrating one embodiment of a method 300 for utilizing a diesel aftertreatment device 112 between the high pressure and low pressure turbine stages 110 and 116 of a two-stage turbocharging system 100. The method 300 substantially includes the embodiments described above with regard to FIGS. 1 and 2.

The method 300 begins by providing 302 a two-stage turbo charging system 100 including a high pressure turbine 110 and a low pressure turbine 116. A diesel aftertreatment device 112 is connected 304 in series between the high pressure turbine and the low pressure turbine such that the diesel aftertreatment device 112 receives inflow from the high pressure turbine 110 and provides outflow to the low pressure turbine 116. Next, a bypass mechanism 106 is provided 306 for bypassing the high pressure turbine 110 and the diesel aftertreatment device 112.

A bypass control module 202 is provided 308 for controlling the operation of the bypass mechanism 106. The bypass control module 202 is configured 310 to operate the bypass mechanism such that the high pressure turbine 110 and the diesel aftertreatment device 112 are bypassed in response to the detection of a predetermined engine operating condition such as an engine load or engine speed. In various embodiments, the detection of an engine speed or load or other operating condition may be dependent on engine sensors such as speed sensors, engine temperature sensors, exhaust temperature sensors, rpm sensors and other sensors as will be recognized by one of skill in the art.

In one embodiment, a second diesel aftertreatment device 208 may be connected to the low pressure turbine 116 such that the second diesel aftertreatment device 208 receives outflow from the low pressure turbine 116. In various embodiments, the second diesel aftertreatment device 112 may be less restrictive than the first diesel aftertreatment device 112, thereby allowing the system 100 to operate more efficiently.

The method 300 ends.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for cleansing emissions in a two-stage turbo charging system, the apparatus comprising:
a two-stage turbo charging system comprising a high pressure turbine and a low pressure turbine; and
a diesel aftertreatment device connected in series between the high pressure turbine and the low pressure turbine such that the diesel aftertreatment device receives inflow from the high pressure turbine and provides outflow to the low pressure turbine.

2. The apparatus of claim 1, further comprising a second diesel aftertreatment device connected to the low pressure turbine such that the second diesel aftertreatment device receives outflow from the low pressure turbine.

3. The apparatus of claim 2, wherein the second diesel aftertreatment device is less restrictive of air flow than is the first diesel aftertreatment device.

4. The apparatus of claim 1, further comprising a bypass mechanism, the bypass mechanism configured to provide inflow to the low pressure turbine such that the high pressure turbine and diesel aftertreatment device can be entirely or partially bypassed.

5. The apparatus of claim 4, further comprising a bypass control module, the bypass control module configured to control the operation of the bypass mechanism.

6. The apparatus of claim 5, wherein the bypass control module is further configured to operate the bypass mechanism such that the high pressure turbine and the diesel aftertreatment device are bypassed in response to the detection of a predetermined engine speed.

7. The apparatus of claim 5, wherein the bypass control module is further configured to operate the bypass mechanism such that the high pressure turbine and the diesel aftertreatment device are bypassed in response to the detection of a predetermined engine load.

8. The apparatus of claim 5, wherein the bypass control module is further configured to operate the bypass mechanism such that the high pressure turbine and the diesel aftertreatment device are bypassed in response to the detection of a predetermined engine operating condition.

9. The apparatus of claim 1, wherein the diesel aftertreatment device is a diesel oxidation catalyst.

10. A system for cleansing emissions in a two-stage turbo charging system, the system comprising:
a vehicle having a motor, an exhaust system, a two-stage turbo charging system, and a diesel aftertreatment device;
wherein the two-stage turbo charging system comprises a high pressure turbine and a low pressure turbine; and
wherein the diesel aftertreatment device is connected in series between the high pressure turbine and the low pressure turbine such that the diesel aftertreatment device receives inflow from the high pressure turbine and provides outflow to the low pressure turbine.

11. The system of claim 10, further comprising a second diesel aftertreatment device connected to the low pressure turbine such that the second diesel aftertreatment device receives outflow from the low pressure turbine.

12. The system of claim 10, further comprising a bypass mechanism, the bypass mechanism configured to provide inflow to the low pressure turbine such that the high pressure turbine and diesel aftertreatment device are bypassed.

13. The system of claim 12, further comprising a bypass control module, the bypass control module configured to control the operation of the bypass mechanism.

14. The system of claim 13, wherein the bypass control module is further configured to operate the bypass mechanism such that the high pressure turbine and the diesel aftertreatment device are bypassed in response to the detection of a predetermined engine speed.

15. The system of claim 13, wherein the bypass control module is further configured to operate the bypass mechanism such that the high pressure turbine and the diesel aftertreatment device are bypassed in response to the detection of a predetermined engine load.

16. The system of claim 13, wherein the bypass control module is further configured to operate the bypass mechanism such that the high pressure turbine and the diesel aftertreatment device are bypassed in response to the detection of a predetermined engine operating condition.

17. The system of claim 11, wherein the diesel aftertreatment device is a diesel oxidation catalyst.

18. A method for filtering emission particulates in a two-stage turbo charging system, the method comprising:
providing a two-stage turbo charging system comprising a high pressure turbine and a low pressure turbine;
connecting a diesel aftertreatment device in series between the high pressure turbine and the low pressure turbine such that the diesel aftertreatment device receives inflow from the high pressure turbine and provides outflow to the low pressure turbine; and
providing a bypass mechanism, the bypass mechanism configured to provide inflow to the low pressure turbine such that the high pressure turbine and diesel aftertreatment device are bypassed.

19. The method of claim 18, further comprising connecting a diesel aftertreatment device catalyst to the low pressure turbine such that the second diesel aftertreatment device receives outflow from the low pressure turbine.

20. The method of claim 18, further comprising providing a bypass control module, the bypass control module configured to control the operation of the bypass mechanism.

21. The method of claim 20, wherein the bypass control module is further configured to operate the bypass mechanism such that the high pressure turbine and the diesel aftertreatment device are bypassed in response to the detection of a predetermined engine speed.

22. The method of claim 18, wherein the bypass control module is further configured to operate the bypass mechanism such that the high pressure turbine and the diesel aftertreatment device are bypassed in response to the detection of a predetermined engine load.

23. The method of claim 20, wherein the bypass control module is further configured to operate the bypass mechanism such that the high pressure turbine and the diesel aftertreatment device are bypassed in response to the detection of a predetermined engine operating condition.
